(19) United States
(12) Patent Application Publication
(10) Pub. No.: US 2008/0158869 A1
(43) Pub. Date: Jul. 3, 2008

(54) Optical Component Assembly for Use in a Direct Backlight Module

(75) Inventors: Chih-Chieh Su, Hsinchu (TW); Chih Kang Wu, Hsinchu (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: AU OPTRONICS CORP., Hsinchu (TW)

(21) Appl. No.: 11/696,911

(22) Filed: Apr. 5, 2007

(30) Foreign Application Priority Data
Dec. 28, 2006 (TW) 95149558

(51) Int. Cl. G02B 26/02

(52) U.S. Cl. 362/214

(57) ABSTRACT

An optical component assembly for use in a direct backlight module is provided. The optical component assembly possesses a light transmitting capability for projecting light emitted from the light source towards at least one specific direction. A pattern, which corresponds to the high-voltage end of the light source, is partially formed on the optical component assembly to retard light transmittance in part of the optical component assembly, and thus, improve the light uniformity provided by the backlight module.

This application claims benefit from the priority of Taiwan Patent Application No. 095149558 filed on Dec. 28, 2006; the disclosures of which are incorporated by reference herein in their entirety.

### CROSS-REFERENCES TO RELATED APPLICATIONS

Not applicable.

### BACKGROUND OF THE INVENTION

1. Field of the Invention

The present invention relates to an optical component assembly for use in a direct backlight module. In particular, the invention relates to an optical component assembly for use in a direct backlight module with single-side driven in a large sized liquid crystal display.

2. Descriptions of the Related Art

Liquid crystal displays (LCDs) have become increasingly popular because they not only save power and emit low radiation, but they are also lightweight and portable. In the past, the LCDs were popular in the small-sized display market only. Nowadays, LCDs have gained a larger market share in the large-sized display market with the progress of manufacturing processes.

The backlight module of the LCD is used to provide a light source for the liquid crystal panel. The large-sized LCD often adopts a direct backlight module to provide sufficient light sources. As shown in FIG. 1, a conventional direct backlight module 10 comprises a reflective film 13, a light source 15 and a diffusion plate 17 which are all disposed within the back bezel 11. The diffusion plate 17 further comprises a diffusion film 171. During use, a portion of light generated by the light source 15 is directly projected towards the diffusion plate 17 and the diffusion film 171 of the liquid crystal panel. However, another portion of light, which are not directly projected, can be reflected back to the diffusion plate 17 by the reflective film 13 disposed on the bottom of the back bezel 11. This portion of light can be used again to enhance the illumination efficiency of the direct backlight module 10.

The conventional light source 15 can be a light emitting diode (LED) array, a cold cathode fluorescent lamp (CCFL), a hot cathode fluorescent lamp (HCFL) or an external electrode fluorescent lamp (EEFL). In the CCFL, which is commonly used today, an inverter is required to provide a driving voltage for illumination. In particular, the inverter can comprise a plurality of inverter components integrated within the circuit board to transform an external voltage (in 24 volts, for example) into a starting voltage (approximately 1000 volts or above) capable of driving the CCFL and providing a rectification effect to independently drive the CCFL.

Although the inverters can be selectively disposed on either side or both sides, the inverters that are disposed on both sides will increase costs. Practically, to reduce costs, the single sided inverters are often adopted. However, using single sided inverters will increase the voltage in the end of the tube which is adjacent to the inverter. The other end then has a lower voltage. Due to this difference, when the backlight module is in operation, parasitic capacitance may occur between the tubes and the back bezel of the backlight module, generating current leakage. The current leakage will result in a loss of tube currents and is more distinct at the low voltage end (i.e. the end opposite to the high voltage end which provides the driving voltage). In other words, the brightness differences between the low voltage end and the high voltage end will be more distinct due to current leakage. When this phenomenon occurs on a large-sized LCD, the brightness is no longer uniform due to the greater distance between the high and low voltage end of the tube.

Given the above, an optical component assembly that can prevent non-uniform brightness, despite the location of the inverters, and can be used in a direct backlight module of a large-sized LCD is needed in this field.

### SUMMARY OF THE INVENTION

The primary objective of this invention is to provide an optical component assembly for use in a direct backlight module that has inverters disposed on one side. The present invention improves the overall uniformity of the panel by retarding the excessive brightness on the high voltage end of the tube adjacent to the inverters.

Another objective of this invention is to provide an optical component assembly for use in a direct backlight module. By forming a pattern on the optical component assembly, the technique of the present invention is suitable for a backlight module with reflective film or a diffusion plate. The reflectivity can be partially adjusted when the technique is applied to the reflective film. Similarly, the diffusivity or transmittance can be partially adjusted when the technique is applied to the diffusion plate to uniform the brightness distribution.

Yet another objective of this invention is to provide an optical component assembly for use in a direct backlight module to retard the excessive brightness in part of the backlight module. The present invention forms a pattern on the optical component assembly. The required cost of this invention is lower than if additional components or particular structures were disposed.

To achieve the aforementioned objectives, the present invention encloses an optical component assembly for use in a direct backlight module, wherein the direct backlight module comprises a light source and a first driving unit. The first driving unit electrically connects with the first end portion of the light source to provide a driving voltage for the light source to generate light. The optical component assembly has light transmitting capability adapted to project the light emitted from the light source towards at least one specific direction. At least one pattern is partially formed on the body of the optical component assembly and substantially corresponds to the first end portion of the light source for retarding the light transmitting capability of the optical component.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is an elevational view illustrating a conventional direct backlight module;

FIG. 2 is a top plane view illustrating the direct backlight module of the present invention;

FIGS. 3A to 3D are schematic views illustrating different types of patterns formed in the optical component assembly of the present invention;

FIG. 4A is a comparison diagram illustrating the brightness of the present invention and the prior art at 80% analog dimming; and

FIG. 4B is a comparison diagram illustrating the brightness of the present invention and the prior art at 30% digital dimming.

### DESCRIPTION OF THE PREFERRED EMBODIMENT

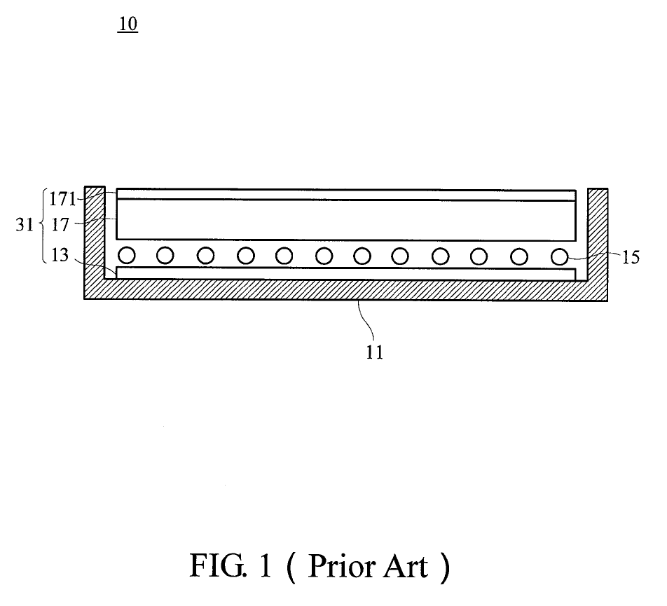

The direct backlight module enclosed in the present invention has a fundamental structure similar to the conventional backlight module. Please refer to the conventional structure as shown in FIG. 1 with the following descriptions to avoid superfluous descriptions.

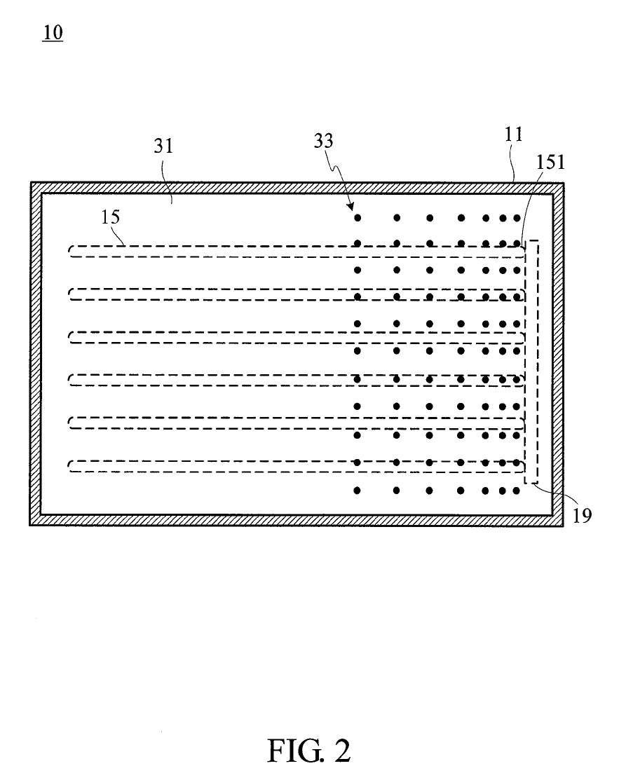

FIG. 2 shows a top view of an optical component assembly 31 of the present invention for use in a direct backlight module 10. The direct backlight module 10 comprises a light source 15 and a first driving unit 19 in a back bezel 11, wherein the light source 15 comprises a plurality of tubes which are substantially in parallel (dotted lines in figures only used to signify the locations). Preferably, the tubes are a plurality of cold cathode fluorescent lamps (CCFLs). For a direct backlight module 10 with single side driving, the first driving unit 19 electrically connects with the first end portion 151 of the light source 15 to provide a driving voltage for the light source 15 to generate light.

The optical component assembly 31 of the present invention has light transmitting capability adapted to project the light emitted from the light source 15 towards at least one specific direction. Specifically, the light is projected towards at least one specific direction that aligns with the user's lines of vision.

As mentioned earlier, the first end portion 151 of the light source 15 will have a first high-voltage end that results in a greater level of brightness. The optical component assembly 31 comprises at least one first pattern 33 substantially corresponding to the first end portion 151 and is partially formed on the body of the optical component assembly 31 for retarding the light transmitting capability of the optical component assembly 31 at the first end portion 151. Preferably, the first pattern 33 comprises a printed pattern disposed behind the first high-voltage end. More preferably, the first pattern 33 is made of light absorption material for partially absorbing the light. For example, the first pattern 33 can be of color, such as black and gray, to better absorb light. In practice, the pattern can be printed by using ink with colors.

The optical component assembly 31 of the present invention can comprise various optical components (such as a reflective film, a diffusion plate and so on), wherein a reflective film 13 disposed behind the light source 15 has a light reflecting capability that projects the light generated from the light source 15 towards the aforementioned plurality of specific directions. A preferred embodiment of the present invention is to coat the first pattern 33 onto the reflective film 13 corresponding to the first high-voltage end, to partially retard the light reflecting capability of the reflective film 13.

The optical component assembly 31 can also be disposed on the diffusion plate 17 in front of the light source 15. The diffusion plate 17 has a light scattering capability that diffuses the light generated from the light source 15 towards the aforementioned plurality of specific directions. Another preferred embodiment of the present invention is coating the first pattern 33 onto the diffusion plate 17 corresponding to the first high-voltage end for partially retarding scattering light.

It can be understood that the diffusion plate 17 can further comprise a diffusion film 171. The first pattern 33 can be selectively coated on the diffusion plate 17 and/or the diffusion film 171. Certainly, the first pattern 33 can be simultaneously coated on both the reflective film 13 and the diffusion plate 17 depending on the requirements.

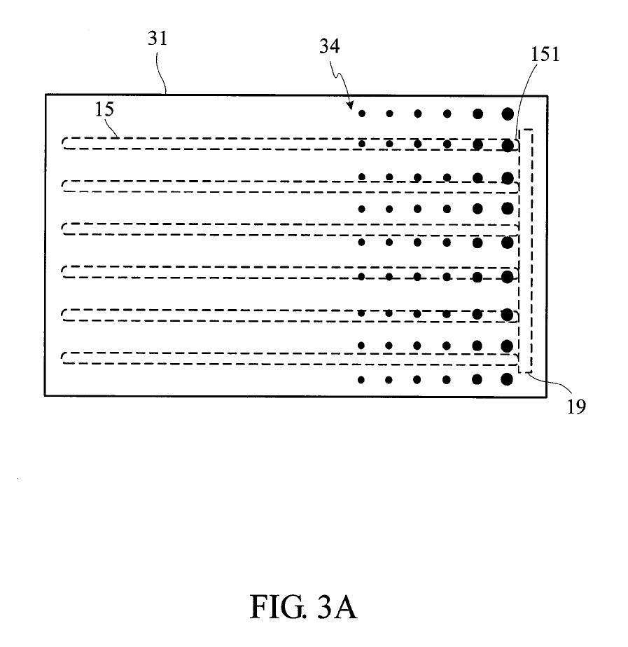

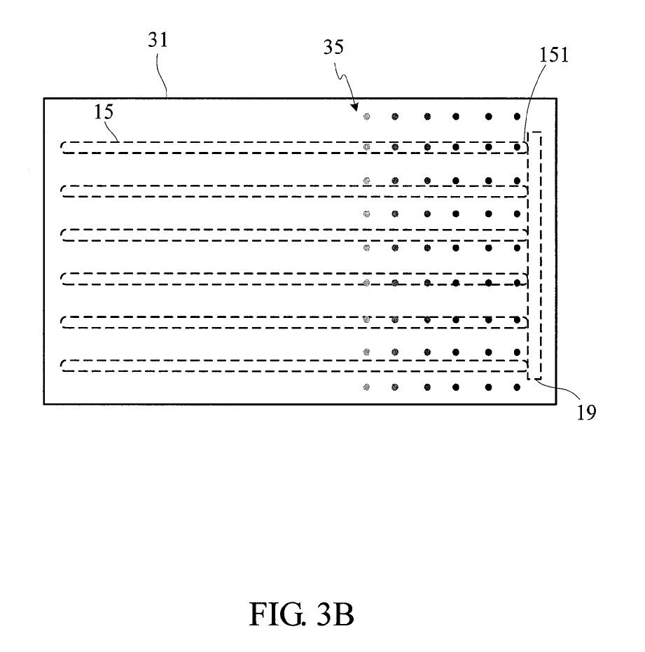

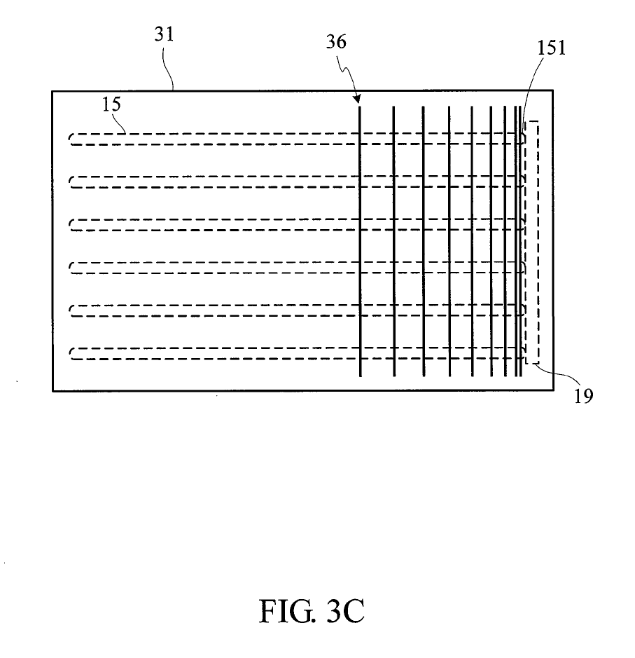

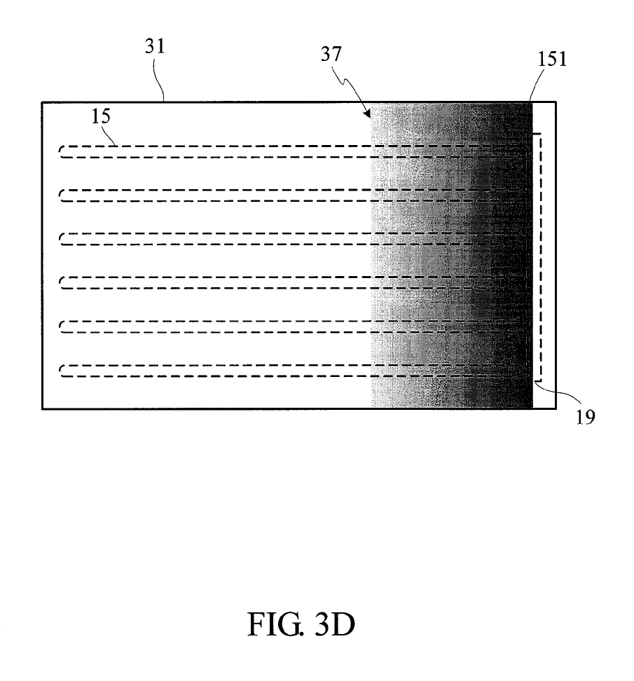

The first pattern 33 disclosed in the present invention comprises various embodiments. For example, the pattern can be selected from the following group: dots, lines, gradients or a combination of the three. The distribution of the patterns can be partially adjusted by density, size or color. For example, as shown in FIG. 2, because the brightness level is higher near the first end portion 151 of the light source 15, the first pattern 33 with dots having a higher distribution density near the first end portion 151 for a better light retarding effect. Furthermore, as shown in FIG. 3A, the first pattern 34 (with dots) can have a larger radius where the pattern is closer at the first end portion 151. The larger radius has the same effect as the aforementioned embodiment with an increased density. As shown in FIG. 3B, the first pattern 35 (with dots) can also be darker (i.e. with a better light absorbing capability) where the pattern is closer to the first end portion 151 to weaken the light transmittance of the optical component assembly 31 near the first end portion 151.

The aforementioned concept using dots can be substituted with lines as shown in FIG. 3C. The first pattern 36 (with lines) has a higher distribution density where the pattern is closer to the first end portion 151. Similarly, the width, darkness and brightness of the lines can be adjusted, as shown in FIG. 3D, by using a first pattern 37 with gradients which are not superfluously described herein. It can be understood that the selections of the first pattern 33, 34, 35, 36 and 37 are only for illustration and do not intend to limit the scope of the present invention. The skills that can be easily modified by people skilled in the art are within the claimed scope of the present invention.

When the direct backlight module with single sided driving of the present invention performs with digital or analog dimming, the improvement in brightness distribution is even more significant. The experimental results of performing brightness tests on the optical component assembly 31 of the present invention are described as follows.

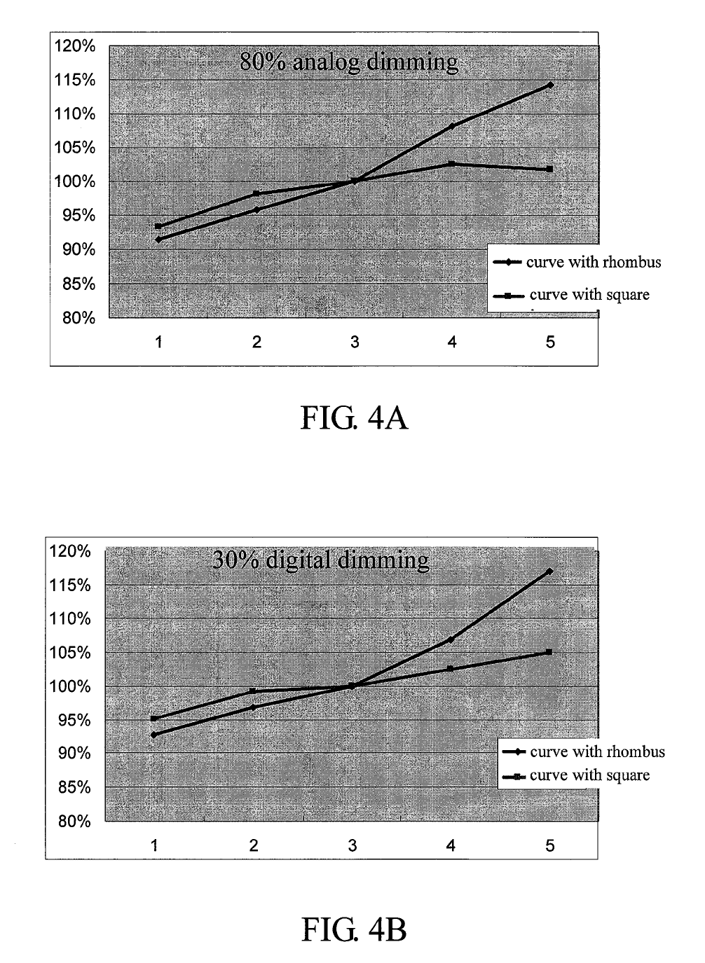

FIG. 4A shows the results of using analog dimming to adjust the overall brightness of the panel from the original status down to 80%. The horizontal axis shows five locations from the left to the right of the panel, while the vertical axis shows the brightness corresponding to the five locations. In other words, the axes describe the brightness levels from the low-voltage end to the high-voltage end. In comparison to the conventional technique (as shown by the curve with rhombus measurement points in the figure), the optical component assembly 31 disposed with the first pattern 33 can effectively retard the brightness of the first high-voltage end (as shown by the curve with square measure points in the figure). Furthermore, the overall brightness representation is more uniform (approximately closer to the required 100% brightness).

FIG. 4B shows the results of using digital dimming to adjust the overall brightness of the panel from the original status down to 30%. The results were similar to the previous experiment.

Since the disclosed techniques of the present invention can improve the high brightness due to the partially high voltage of the tube adjacent to the driving unit, the invention can certainly also be adapted to a backlight module with double side driving (not shown in the figures). In the backlight light module with double side driving, the light source further comprises a second end portion corresponding to the first end portion. The second driving unit electrically connects with the second end portion and the first driving unit to provide a driving voltage for the light source. As expected, the first and second end portions are the first and second high-voltage ends, respectively. Meanwhile, the patterns of the present invention can comprise two printed patterns (i.e. the first pattern and the second pattern in the present invention) respectively disposed behind the first and second high-voltage ends to obtain a more uniform light source. Similar to the abovementioned first pattern, the second pattern is formed on the optical component assembly 31 corresponding to the second end portion. The second pattern may comprise dots, lines, gradients or a combination thereof. The second pattern can also be made of the light absorbing materials.

According to the aforementioned disclosures, patterns can be disposed onto the optical component assembly of the invention to effectively retard the excessive brightness where there is a greater level of brightness, so as to obtain a more uniform light source.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An optical component assembly for use in a direct backlight module, the direct backlight module comprising a light source and a first driving unit, in which the light source has a first end portion which electrically connects with the first driving unit, to provide a driving voltage for the light source in order to generate a light, the optical component assembly having light transmitting capability adapted to project the light emitted from the light source toward at least one specific direction, the optical component assembly comprising:
a body; and
at least one first pattern, being partially formed on the body and substantially corresponding to the first end portion.

2. The optical component assembly as claimed in claim 1, wherein the first pattern includes dots, lines, gradients, or the combination thereof.

3. The optical component assembly as claimed in claim 1, wherein the first pattern is made of light absorption material.

4. The optical component assembly as claimed in claim 1, wherein the light source has a first high-voltage end, which forms the first end portion of the light source.

5. The optical component assembly as claimed in claim 4, wherein the at least one specific direction comprises a plurality of a user's lines of vision.

6. The optical component assembly as claimed in claim 4, wherein the optical component assembly comprises a reflective film disposed behind the light source.

7. The optical component assembly as claimed in claim 4, wherein the optical component assembly comprises a diffusion plate disposed in front of the light source.

8. The optical component assembly as claimed in claim 4, wherein the optical component assembly comprises a diffusion plate disposed in front of the light source and a diffusion film disposed in front of the diffusion plate.

9. The optical component assembly as claimed in claim 4, wherein the optical component assembly comprises a reflective film disposed behind the light source and a diffusion plate disposed in front of the light source.

10. The optical component assembly as claimed in claim 4, wherein the direct backlight module further comprises a second driving unit and the light source has a second end portion opposite to the first end portion, the first and second driving units being electrically connected and electrically connecting with the first and second end portions, respectively, for providing the driving voltage for the light source.

11. The optical component assembly as claimed in claim 10, wherein the light source has a second high-voltage end, which forms the second end portion of the light source.

12. The optical component assembly as claimed in claim 11, further comprising at least one second pattern, being partially formed on the body and substantially corresponding to the second end portion.

13. The optical component assembly as claimed in claim 12, wherein the second pattern includes dots, lines, gradients, or the combination thereof.

14. The optical component assembly as claimed in claim 12, wherein the second pattern is made of light absorption material.

15. The optical component assembly as claimed in claim 1, wherein the light source comprises a plurality of tubes which are substantially parallel with one another.

16. The optical component assembly as claimed in claim 1, wherein each of the tubes is a cold cathode fluorescent lamp (CCFL).

17. An optical component, having light transmitting capability adapted to project a light toward at least one specific direction, the optical component comprising:
a surface, having a first end portion; and
at least one pattern, being at least partially formed on the first end portion of the surface, for retarding the light transmitting capability of the optical component at the first end portion.
